(19) United States
(12) Patent Application Publication
(10) Pub. No.: US 2013/0194967 A1
(43) Pub. Date: Aug. 1, 2013

(54) NODE CAPABILITIES DETECTION METHOD AND SYSTEM

(71) Applicants: Bob Melander, Sigtuna (SE); Jan-Erik Mangs, Solna (SE); Lars Westberg, Enköping (SE)

(72) Inventors: Bob Melander, Sigtuna (SE); Jan-Erik Mangs, Solna (SE); Lars Westberg, Enköping (SE)

(73) Assignee: TELEFONAKTIEBOLAGET L M ERICSSON (PUBL), Stockholm (SE)

(21) Appl. No.: 13/581,489

(22) PCT Filed: Mar. 5, 2010
(86) PCT No.: PCT/IB2010/001258

§ 371 Date: Dec. 13, 2012

(51) Int. Cl. H04L 12/24

(52) U.S. Cl. CPC H04L 41/0803
USPC 370/254

(57) ABSTRACT

A system and method for disseminating node related capability information in a communication network. The method includes receiving an activation trigger at a first node that is part of the communication network; determining at the first node, based on the received activation trigger, whether first node related capability information or second node related capability information is to be sent to neighboring nodes; processing the first node related capability information or the second node related capability information at the first node before sending it to the neighboring nodes such that the node related capability information is added as one or more entries to the pre-established message structure; and disseminating the first node related capability information or the second node related capability information from the first node to the neighboring nodes.

### TECHNICAL FIELD

The present invention generally relates to systems, software and methods and, more particularly, to mechanisms and techniques for determining node capabilities inside a network.

### BACKGROUND

The improvements in network connectivity during the past years has opened new opportunities for computing devices such as computers, mobile phones, game consoles, personal digital assistants, etc., e.g., to receive assistance from processing elements available inside a network to which the computing devices may connect. In such ways, the computing devices may make use of the network available processing elements for solving, for example, computational tasks that cannot be solved by the processors of the computing devices or will take too long.

Thus, there is an increasing interest in providing general and/or specific purpose processing elements, e.g., virtualized servers with temporary and persistent storage, inside the operator networks. The processing elements may be self-contained traditional servers, or may be server blades collocated with network equipment such as a traditional router or switch. However, the processing elements may also be a completely new kind of network equipment with specialized hardware for optimized throughput but built around an architecture where hypervisor-based virtualization is a central component (such equipment is sometimes referred to in the literature as substrate nodes).

Some advantages gained by providing processing elements in the network are related to (among several others): achieving traffic reduction by means of caching (e.g., caching popular video clips from sites like, for example, youtube.com); improving end user experience by reducing latency (e.g., adapting dynamic web content near the end user rather than at the source web site); hosting software-based network nodes for virtual network operators or enterprises in dedicated (virtual) network slices; providing in-network virtual computational resources as part of an Infrastructure-as-a-Service (IaaS) offering to operator customers or application service providers, etc.

Thus, a traditional scenario is illustrated in FIG. 1. A system 10 includes multiple users 12, 14, 16, and 18, which may be using a personal computer, a mobile phone, a personal digital assistant, a netbook, or any other electronic device that has communication capabilities. These users 12, 14, 16, and 18 connect for communication purposes to the network operator 20. The network operator 20 may include Internet connectivity but also a wireless or wired connectivity that is typical for a phone network. The two functionalities, Internet and phone, may be supported by a same physical network or by different physical networks. The network operator 20 may connect to various data centers 22 and 24, for example, youtube.com or google.com. The providers may have their own internal networks and their own internal processing elements (not shown). Processing elements 26, 28, 30, 32, and 34 inside the operator network 20 complement the processing elements (e.g., servers) that are hosted in data centers 22 and 24. These data centers 22 and 24 typically have high-bandwidth connectivity but lack proximity to users 12, 14, 16, and 18.

Thus, for the implementation of a particular service (provided by data centers) that needs processing capabilities in the operator network 20, it is likely that several processing elements in the operator network 20 are required. The efficient usage of these elements depends on many factors, one of which is the design of the service. One possible case is that the service includes a set of chained processing steps A, B, C, D, etc. that need to be allocated in a certain order to processing elements PE_{A}, PE_{B}, PE_{C}, PE_{D}, etc. as shown in FIG. 2.

There are typically a set of requirements for the entire processing chain. One such requirement can be that the end-to-end delay is less than some time value T as shown in FIG. 2. The end-to-end (or full system) requirements can in turn be translated into requirements for each process step. FIG. 2 illustrates the time requirements for each process step by time constraints t_{A}, t_{B}, etc. In order to successfully deliver the service to the user, the appropriate processing elements PE_{A}, PE_{B}, PE_{C}, PE_{D}, etc. need to be allocated according to the above noted requirements. This provisioning problem applies to both networking (connectivity) and processing resources.

However, the existing networks rarely include general purpose processing elements that are made available as virtualized resources. Further, existing protocols that are designed to discover, allocate, provision and configure resources in the operator networks are limited mainly to connectivity resources (e.g., optical links, Multi Protocol Label Switching (MPLS) paths, layer 2 and 3 Virtual Private Networks (VPNs), etc.) and fail to discover, allocate, provision and configure the processing elements required by various services as discussed above.

Accordingly, it would be desirable to provide devices, systems and methods that are capable to discover, allocate, provision and configure processing elements required by a general service.

### SUMMARY

Processing elements that are used by various services (not only related to connectivity) are distributed in the operator network. Novel methods and systems discussed later are capable of discovering the processing elements located at multiple locations in the operator network and building a database (consistent across multiple nodes) with information about the processing element capabilities, properties and status, among other things.

According to one exemplary embodiment, there is a method for disseminating node related capability information in a communication network that uses a communication protocol having a pre-established message structure including plural entries arranged in a fixed format, none of the entries being designed to include the node related capability information. The method includes receiving an activation trigger at a first node that is part of the communication network; determining at the first node, based on the received activation trigger, whether first node related capability information or second node related capability information is to be sent to neighboring nodes; processing the first node related capability information or the second node related capability information at the first node before sending it to the neighboring nodes such that the node related capability information is added as one or more entries to the pre-established message structure; and disseminating the first node related capability information or the second node related capability information from the first node to the neighboring nodes.

According to another exemplary embodiment, there is a node configured to disseminate node related capability information in a communication network that uses a communication protocol and a pre-established message structure having plural entries arranged in a fixed format, none of the entries being designed to include the node related capability information. The node includes an input/output interface configured to receive an activation trigger and a processor. The processor is configured to determine, based on the received activation trigger, whether the node related capability information or another node related capability information is to be sent to neighboring nodes, process the node related capability information or the another node related capability information before sending it to the neighboring nodes such that the node related capability information is added as one or more entries to the pre-established message structure, and disseminate the node related capability information or the another node related capability information from the node to the neighboring nodes.

According to still another exemplary embodiment, there is a computer readable medium including computer executable instructions, where the instructions, when executed, implement a method as noted above.

It is an object to overcome some of the deficiencies discussed in the previous section and to provide a mechanism for discovering the processing elements and gathering information related to the capabilities, distribution and status of the processing elements. One or more of the independent claims advantageously extends an existing protocol for gathering the information for the database.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a schematic diagram of a traditional network;

FIG. 2 is a diagram indicating how various a service is distributed to multiple processing elements for execution;

FIG. 3 is a schematic diagram of a network that includes at least a node configured to detect capabilities of other nodes according to an exemplary embodiment;

FIG. 4 is a schematic diagram indicating an interaction between various nodes of a network according to an exemplary embodiment;

FIG. 5 is a flow chart illustrating a method for determining capabilities of nodes in a network according to an exemplary embodiment; and

FIG. 6 is a schematic diagram of a node.

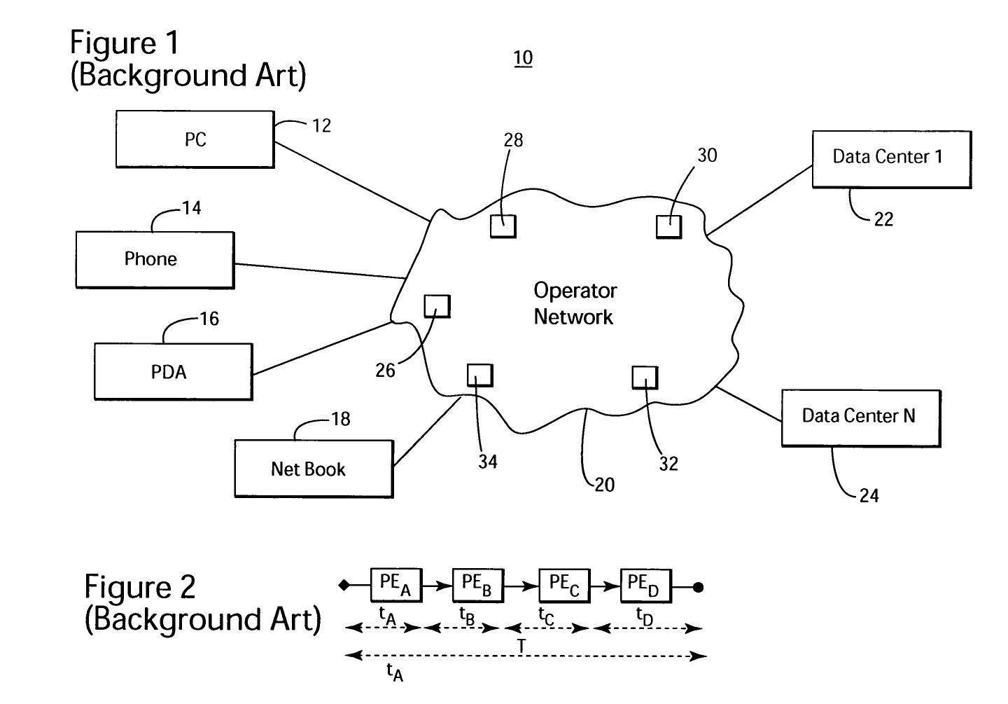

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of a network using Open Shortest Path First (OSPF) protocol. However, the embodiments to be discussed next are not limited to this network but may be applied to other networks using other protocols, e.g., Intermediate System to Intermediate System (IS-IS) protocol.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification is not necessarily all referring to the same embodiment. Further, the particular features, structures or characteristics may be combined in any suitable manner in one or more embodiments.

According to an exemplary embodiment, an operator network includes plural nodes distributed throughout the network. The network may use the OSPF and/or OSPF-Traffic Engineering (OSPF-TE) protocols. New description entities and functional behavior are added to this protocol to capture desired information about the nodes. This information is collected for establishing a database (either centrally located in the operator network or distributed in the network) including information about the nodes required by a general service provided by or over the operator network.

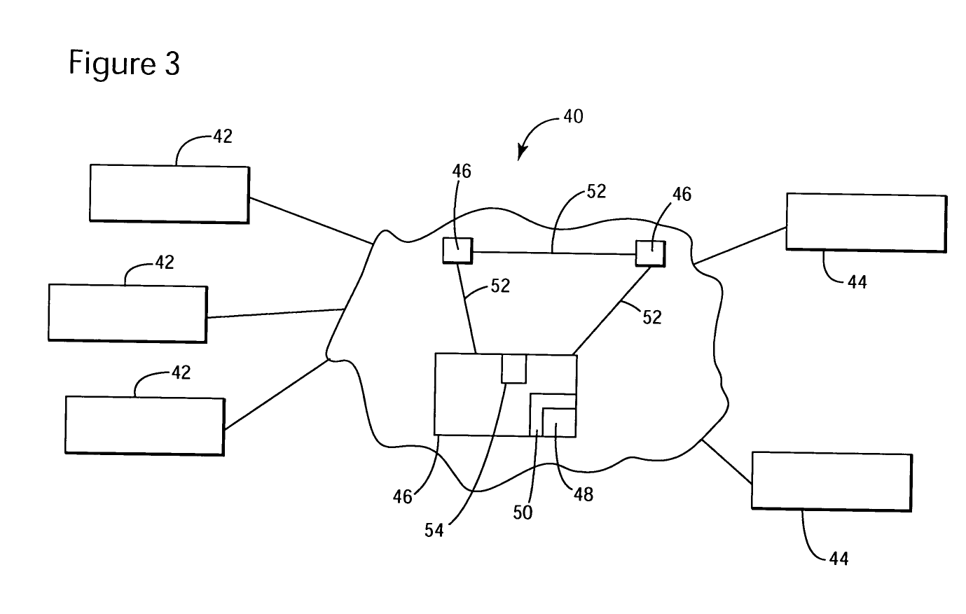

According to an exemplary embodiment illustrated in FIG. 3, a network operator 40 is configured to communicate with user devices 42 and also with data centers 44. The user devices 42 may be any electronic device that is capable of sending information wireless or wired over a network. Data centers 44 may include a computing resource facility used by a service provider that offers a service to the users. It is noted that user devices 42 exchange information with the data centers 44 over operator network 40. Operator network 40 may include a physical network with controlled access of the user devices 42, that may be implemented as a traditional phone network and/or based on Internet Protocol (IP), MPLS, Openflow or other computer communication technologies. In one application, the operator network includes a traditional phone network and a different IP network. The two networks may be configured to communicate to each other.

The operator network 40 includes one or more nodes 46 distributed inside the network. A node (or processing element) may be any of a processor, router, router with a (generic) processing blade, server, MPLS enabled router, etc. At least a node 46 runs an OPSF daemon (OD) 48 on a processor or dedicated circuitry 50. More than one node may run its own OD 48 on a corresponding processor 50. Node 46 may also include a memory 54. Processor 50 is connected to the memory 54 and is configured to store or access information stored in memory 54. The various nodes 46 are configured to be able to communicate with each other inside the operator network 40 via links 52. As noted at the beginning of this section, the OPSF protocol is used for simplicity. However, the novel concepts discussed in the exemplary embodiments are applicable to other protocols.

The OPSF protocol is now discussed briefly for a better understanding of the messaging that takes place among the various nodes 46. A feature of the OPSF protocol and other protocols (IS-IS) is the link-state routing protocol. The link-state routing protocol is one of the two classes of routing protocols used in packet switching networks for computer communications, the other class being the distance-vector routing protocol.

The link-state protocol is performed by every switching node in the network (i.e., nodes that are prepared to forward packets; in the Internet, these are called routers). A basic concept of link-state routing is that every node constructs a map of the connectivity to the network, in the form of a graph, showing which nodes are connected to which other nodes. Each node then independently calculates the next best logical hop from it to every possible destination in the network. The collection of best next hops will then form the node's routing table.

The link-state protocol contrasts with distance-vector routing protocols, which work by having each node share its routing table with its neighbors. In a link-state protocol the only information passed between nodes is connectivity related. In other words, each router “tells the world” about its neighbors.

The link-state protocol instructs each node to periodically and in case of connectivity changes to make up a short message, the link-state advertisement (LSA), which identifies the node which is producing it, identifies all the other nodes to which it is directly connected, and includes a sequence number, which increases every time the source node makes up a new version of the message. This message is then flooded throughout the network.

Another protocol to which the exemplary embodiments may be applied is the IS-IS. The IS-IS is a protocol used by network devices (e.g., routers) to determine the best way to forward datagrams through a packet-switched network, a process called routing. IS-IS is not an Internet standard.

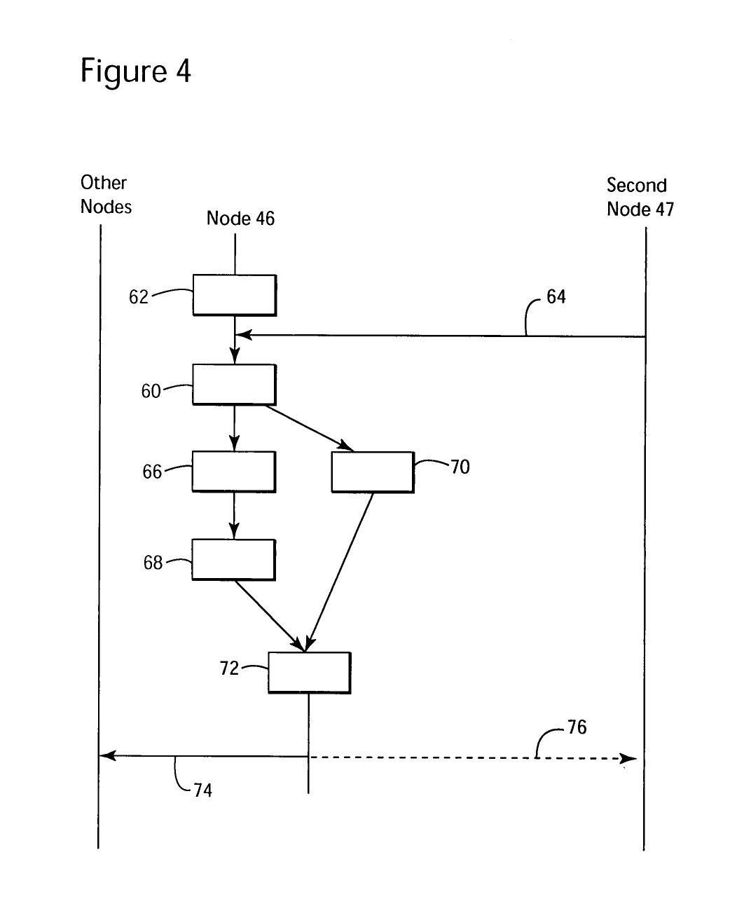

With this understanding of OSPF, according to an exemplary embodiment illustrated in FIG. 4, the OD 48 of a first node 46 is configured to look for an activation trigger. The activation trigger, when received, determines the first node 46 to perform certain actions (one of which may be dissemination) as discussed next. The OD 48 is configured to determine in step 60 whether the first node, based on the activation trigger, sends first node related capability information or second node related capability information to neighboring nodes of the first node. A neighboring node is identified in FIG. 4 as second node 47.

The activation trigger may be generated by the first node 46 in step 62. Step 62 is taking place prior in time to step 60. Step 62 may be initiated by a change in the local configuration of the first node 46. Examples of such changes may be, for example, a reduction in the available memory at the first node 46, an increase in the processor speed, an offline status, etc. The local configuration change may include other changes in the configuration of the first node 46 as long as these changes affect in any way the service to be provided by the network 40.

Alternatively, the activation trigger may be generated by a second node 47 in step 64. A change in the local configuration of the second node or another nodes may determine the generation of an OSPF LSA message in the second node. Upon receiving the OSPF LSA message in step 64 from the second node 47, the first node 46 executes step 60. The activation trigger may be related to other events that call for dissemination of local node information.

After determining in step 60 whether the activation trigger is generated by the first node 46 or other nodes, the first node 46 executes the following steps. If the activation trigger was generated in step 62, the OD 48 of the first node 46 collects in step 66 node related information for the first node 46. Examples of the node related information includes but is not limited to a number of processing cores of the first node, a processing core frequency, total amount of memory, maximally reservable amount of memory, total amount of disk space of the first node, reservable amount of disk space of the first node, whether hypervisor technology is supported, geographic coordinates of the first node, operating system, virtualization technology (like hypervisor type and version), performance evaluation numbers such as SPECmarks, or IP address of the first node.

The above noted information collected in step 66 may be processed in step 68 such that a local database that may be stored in the memory 54 (see FIG. 3) in the first node 46 includes this information. In one application, the OD 48 incorporates this information into OSPF message fields. For example, the information is included in a type 10 opaque LSA created by OD 48, where Type/Length/Value (TLV) triplets for all processing related information is included (see for example, RFC3630 document of IETF that defines the OSPF and TLV in detail). In other words, the OD 48 is configured to modify existing fields in a given structure of the messages of OSPF to include the desired information, e.g., node related information.

However, if it is determined in step 60 that the activation trigger is generated by the second node 47, the node related information that is stored in a OSPF LSA received from the second node 47 is incorporated in step 70 into the local database (local information database (LID)) of the first node 46. The LID may be a traditional OSPF LSA database extended with fields for node related information.

After performing step 68 or step 70, the first node 46 prepares in step 72 an LSA having updated information about the capabilities of the first node or the second node and floods in step 74 other nodes of the network 40. Step 74 may include an optional step 76 that takes place only if the updated information was determined by a change in the local configuration of the first node 46.

Therefore, the node related capabilities propagate from node to node in the operator network and each node has the possibility to update a local LID with regard to the capabilities of the other nodes. In this way, a database of nodes capabilities is generated while extending an existing communication protocol. Thus, one or more exemplary embodiments provides a distributed mechanism to build a topology of nodes and their capabilities. The mechanism may piggy-back on well-established protocols, as OSPF or IS-IS protocols and requires minor changes to the OSPF daemon implementations. OSPF daemons that do not support these extensions are still capable of forwarding the LSA packets that include the new information, which allows for a simplified migration since the network can gradually be upgraded. In this regard, it is noted that an OSPF daemon that does not support these extensions would not be able to read the information stored in the extensions but this would not impede the proper functioning of such a node/daemon. Further, the daemon/node that is not able to read the information is still capable to forward that information in the LSA messages to the neighboring nodes.

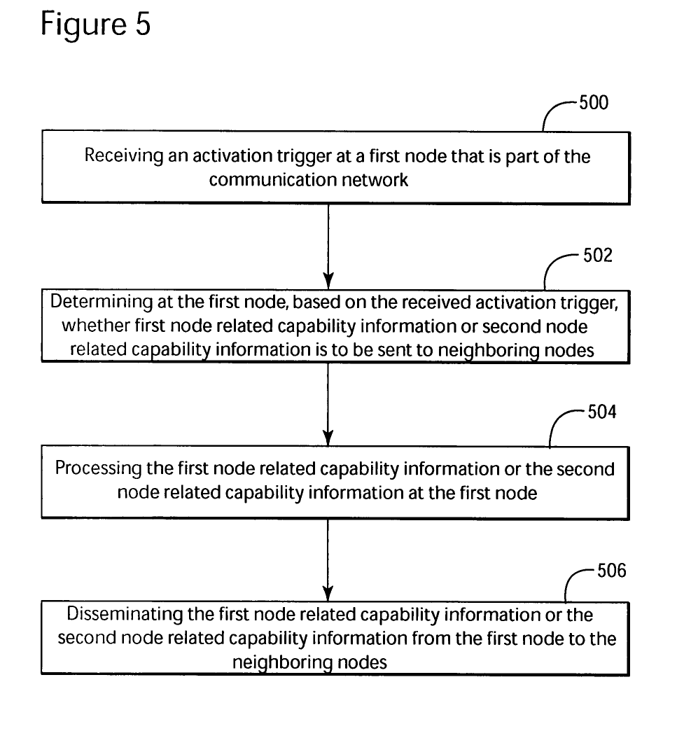

According to an exemplary illustrated in FIG. 5, there is a method for disseminating node related capability information in a communication network that uses a communication protocol having a pre-established message structure including plural entries arranged in a fixed format, none of the entries being designed to include the node related capability information. The method includes a step 500 of receiving an activation trigger at a first node that is part of the communication network, a step 502 of determining at the first node, based on the received activation trigger, whether first node related capability information or second node related capability information is to be sent to neighboring nodes, a step 504 of processing the first node related capability information or the second node related capability information at the first node before sending it to the neighboring nodes such that the node related capability information is added as one or more entries to the pre-established message structure, and a step 506 of disseminating the first node related capability information or the second node related capability information from the first node to the neighboring nodes.

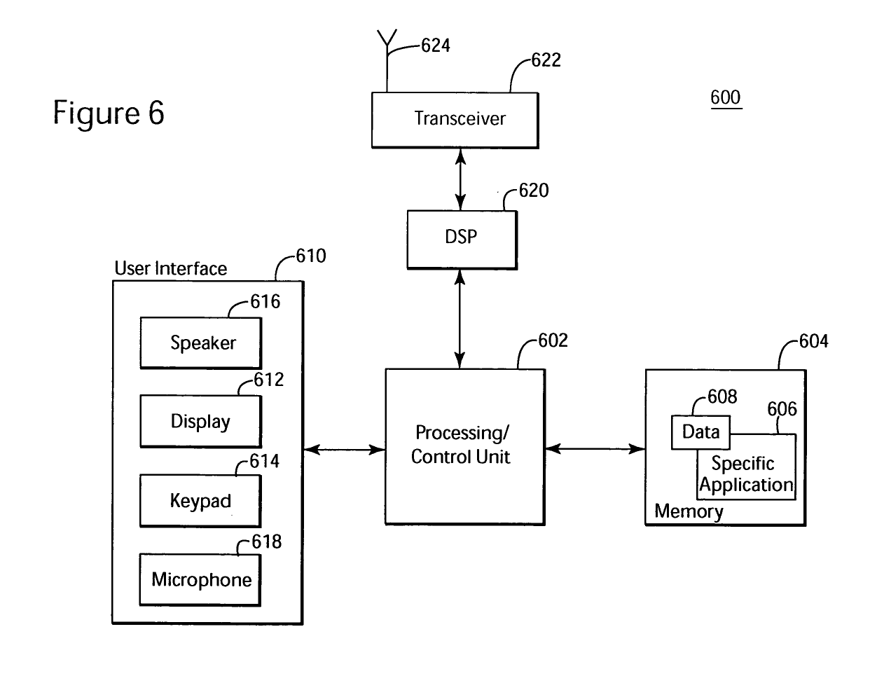

For purposes of illustration and not of limitation, an example of a representative node capable of carrying out operations in accordance with the exemplary embodiments is illustrated in FIG. 6. It should be recognized, however, that the principles of the present exemplary embodiments are equally applicable to other computing systems.

The exemplary node 600 may include a processing/control unit 602, such as a microprocessor, reduced instruction set computer (RISC), or other central processing module. The processing unit 602 need not be a single device, and may include one or more processors. For example, the processing unit 602 may include a master processor and associated slave processors coupled to communicate with the master processor. Alternatively, the processing unit 602 may have the structure shown in FIG. 3.

The processing unit 602 may control the basic functions of the system as dictated by programs available in the storage/memory 604. Thus, the processing unit 602 may execute the functions described in FIGS. 3 and 4. More particularly, the storage/memory 604 may include an operating system and program modules for carrying out functions and applications on the node. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the node 600 via data signals, such as being downloaded electronically via a network, such as the Internet.

One of the programs that may be stored in the storage/memory 604 is a specific program 606. As previously described, the specific program 606 may interact with the LSA messages to extract or include appropriate information. The program 606 and associated features may be implemented in software and/or firmware operable by way of the processor 602. The program storage/memory 604 may also be used to store data 608, such as node configuration, or other data associated with the present exemplary embodiments. In one exemplary embodiment, the programs 606 and data 608 are stored in non-volatile electrically-erasable, programmable ROM (EEPROM), flash ROM, etc. so that the information is not lost upon power down of the node 600.

The processor 602 may also be coupled to user interface 610 elements associated with a mobile terminal. The user interface 610 of the mobile terminal may include, for example, a display 612 such as a liquid crystal display, a keypad 614, speaker 616, and a microphone 618. These and other user interface components are coupled to the processor 602 as is known in the art. The keypad 614 may include alpha-numeric keys for performing a variety of functions, including dialing numbers and executing operations assigned to one or more keys. Alternatively, other user interface mechanisms may be employed, such as voice commands, switches, touch pad/screen, graphical user interface using a pointing device, trackball, joystick, or any other user interface mechanism.

The node 600 may also include a digital signal processor (DSP) 620. The DSP 620 may perform a variety of functions, including analog-to-digital (ND) conversion, digital-to-analog (D/A) conversion, speech coding/decoding, encryption/decryption, error detection and correction, bit stream translation, filtering, etc. The transceiver 622, generally coupled to an antenna 624, may transmit and receive the radio signals associated with a wireless device.

The node 600 of FIG. 6 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 606 and associated features, and data 608, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

The disclosed exemplary embodiments provide a node system, a method and a computer program product for generating a database indicative of node capabilities in a network. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

As also will be appreciated by one skilled in the art, the exemplary embodiments may be embodied in a wireless communication device, a telecommunication network, as a method or in a computer program product. Accordingly, the exemplary embodiments may take the form of an entirely hardware embodiment or an embodiment combining hardware and software aspects. Further, the exemplary embodiments may take the form of a computer program product stored on a computer-readable storage medium having computer-readable instructions embodied in the medium. Any suitable computer readable medium may be utilized including hard disks, CD-ROMs, digital versatile disc (DVD), optical storage devices, or magnetic storage devices such a floppy disk or magnetic tape. Other non-limiting examples of computer readable media include flash-type memories or other known memories.

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a specifically programmed computer or processor.

1. A method for disseminating node related capability information in a communication network that uses a communication protocol having a pre-established message structure including plural entries arranged in a fixed format, none of the entries being designed to include the node related capability information, the method comprising:
receiving an activation trigger at a first node that is part of the communication network;
determining at the first node, based on the received activation trigger, whether first node related capability information or second node related capability information is to be sent to neighboring nodes;
processing the first node related capability information or the second node related capability information at the first node before sending it to the neighboring nodes such that the node related capability information is added as one or more entries to the pre-established message structure; and
disseminating the first node related capability information or the second node related capability information from the first node to the neighboring nodes.

2. The method of claim 1, wherein the communication protocol is a pre-established communication protocol that is not configured to include the node related capability information.

3. The method of claim 2, the step of processing further comprising:
modifying the pre-established message structure to include the first or second node related capability information.

4. The method of claim 1, wherein the first and second node related capability information includes at least one of a number of processing cores of a node, a processing core frequency, total amount of memory, maximally reservable amount of memory, total amount of disk space of the node, reservable amount of disk space of the node, whether hypervisor technology is supported, geographic coordinates of the node, information about an operating system, virtualization technology, performance evaluation numbers, or IP address of the node.

5. The method of claim 1, wherein the communication protocol is one of Open Shortest Path First or Intermediate System to Intermediate System.

6. The method of claim 5, wherein the pre-established message structure is Link State Advertisement and the LSA is configured to flood an area around the first node for transmitting information to the neighbouring nodes.

7. The method of claim 6, wherein the processing step further comprises:
creating a type 10 opaque LSA message in which type/length/value triplets are included for all node related capability information.

8. The method of claim 1, wherein the first node includes a daemon configured to execute the processing step by piggy-backing on an established Open Shortest Path First protocol.

9. The method of claim 1, wherein the first node is one of a router, router with a generic processing blade, a server, Multi Protocol Label Switching enabled router, a processor, an Openflow enabled device, an Openflow enabled device with a generic processing blade, a switch, a switch with a generic processing blade, a personal computer, or a mobile phone.

10. The method of claim 1, wherein the activation trigger received at the first node is one of a communication protocol message from the second node, detected changes in a configuration of the first node, or an event that calls for disseminating the configuration of the first node.

11. The method of claim 10, wherein the determining step further comprises:
if the activation trigger is one of the detected changes in the configuration of the first node or the event that calls for disseminating the configuration of the first node, collecting the first node related capability information from the first node and creating the communication protocol message for the first node to be distributed to the neighboring nodes; and
if the activation trigger is a communication protocol message from the second node, extracting the second node related capability information and storing it in a first node local information database.

12. A node configured to disseminate node related capability information in a communication network that uses a communication protocol and a pre-established message structure having plural entries arranged in a fixed format, none of the entries being designed to include the node related capability information, the node comprising:
an input/output interface configured to receive an activation trigger; and
a processor configured to,
determine, based on the received activation trigger, whether the node related capability information or another node related capability information is to be sent to neighboring nodes,
process the node related capability information or the another node related capability information before sending it to the neighboring nodes such that the node related capability information is added as one or more entries to the pre-established message structure, and
disseminate the node related capability information or the another node related capability information from the node to the neighboring nodes.

13. The node of claim 12, wherein the communication protocol is not configured to include the node related capability information.

14. The node of claim 13, wherein the processor is further configured to:
modifying the pre-established message structure to include the node or another node related capability information.

15. The node of claim 12, wherein the node and another node related capability information includes at least one of a number of processing cores of a node, a processing core frequency, total amount of memory, maximally reservable amount of memory, total amount of disk space of the node, reservable amount of disk space of the node, whether hypervisor technology is supported, geographic coordinates of the node, information about an operating system, virtualization technology, performance evaluation numbers or IP address of the node.

16. The node of claim 12, wherein the communication protocol is one of Open Shortest Path First or Intermediate System to Intermediate System.

17. The node of claim 16, wherein the pre-established message structure is Link State Advertisement and the LSA is configured to flood an area around the node for transmitting information to the neighbouring nodes.

18. The node of claim 17, wherein the processor is further configured to:
create a type 10 opaque LSA message in which type/length/value triplets are included for all node related capability information.

19. The node of claim 12, wherein the node is one of a router, router with a generic processing blade, a server, Multi Protocol Label Switching enabled router, a processor, an Openflow enabled device, an Openflow enabled device with a generic processing blade, a switch, a switch with a generic processing blade a personal computer, or a mobile phone.

20. The node of claim 12, wherein the activation trigger received at the node is one of a communication protocol message from the another node, detected changes in a configuration of the node, or an event that calls for disseminating the configuration of the node, and the processor is further configured to,
if the activation trigger is one of the detected changes in the configuration of the node or the event that calls for disseminating the configuration of the node, collecting the node related capability information from the node and creating a communication protocol message for the node to be distributed to the neighboring nodes; and
if the activation trigger is the pre-established communication protocol message from the another node, extracting the another node related capability information and storing it in a node local information database.
